(19) United States
(12) Patent Application Publication
(10) Pub. No.: US 2015/0296812 A1
(43) Pub. Date: Oct. 22, 2015

(54) EDIBLE COLLAGEN CASINGS FINISHED WITH POLYSORBAT

(71) Applicants: Richard E. Battersby, Frenchtown, NJ (US); Eugene Goldfarb, Marlboro, NJ (US); Mydiam A. Soto, Perth Amboy, NJ (US); Stacey S. Hamblin, Millville, NJ (US)

(72) Inventors: Richard E. Battersby, Frenchtown, NJ (US); Eugene Goldfarb, Marlboro, NJ (US); Mydiam A. Soto, Perth Amboy, NJ (US); Stacey S. Hamblin, Millville, NJ (US)

(73) Assignee: NITTA CASINGS INC., Bridgewater, NJ (US)

(21) Appl. No.: 14/687,757

(22) Filed: Apr. 15, 2015

Related U.S. Application Data
(60) Provisional application No. 61/980,131, filed on Apr. 16, 2014.

(51) Int. Cl. A22C 13/00

(52) U.S. Cl. CPC A22C 13/0016

(57) ABSTRACT

An improved collagen casing is produced by applying a suspension of a polysorbate in vegetable oil to the collagen film. The collagen casing exhibits improved qualities over collagen casing, such as reduced fading of dyed collagen casings when exposed to UV light.

This application claims priority under 35 U.S.C. §119 to U.S. Provisional Application

No. 61/980,131 filed on Apr. 16, 2014, the contents of which are incorporated herein by reference.

### BACKGROUND OF THE INVENTION

Reconstituted collagen is widely used in the manufacture of tubular casings for meat products such as sausage. The collagen used in these casings is usually derived from the corium layer of bovine hides. The collagen raw material is comminuted, and mixed with a swelling agent to produce a uniform dispersion from which a continuous tube is formed. The tube is then neutralized by the injection of gaseous ammonia or by contact with a liquid salt solution. The casing is washed in water to remove neutralization salts, plasticized by passing it through successive liquid baths and dried while inflated. Examples of such processes are disclosed in U.S. Pat. No. 3,535,125, 3,821,439, 4,388,331, and 5,820,812, the entire contents of each of which are hereby incorporated by reference.

The present invention is directed to edible collagen casings finished by applying a mixture of vegetable oil and polysorbate, so as to produce a final product that will have improved quality characteristics as seen by the customer.

### SUMMARY OF THE INVENTION

Edible collagen tubular casing is produced using conventional techniques. The final collagen casing product is treated by applying a mixture of vegetable oil and polysorbate to the collagen film. The treated casing is then shirred to a specified length, boxed, and shipped to the customer.

Among the advantages of the process are that a better quality collagen casing is produced, particularly when used with high shear stuffing. In addition, where the collagen casing is dyed with a red dye, such as red dye number 3, applying the polysorbate/vegetable oil mixture extends the time for fading of the color, thereby giving the product a shelf life advantage.

### BRIEF DESCRIPTION OF THE DRAWINGS

FIG. 1 is a schematic showing one embodiment of a process by which limed hides are processed into edible casings.

### DETAILED DESCRIPTION OF EMBODIMENTS OF THE INVENTION

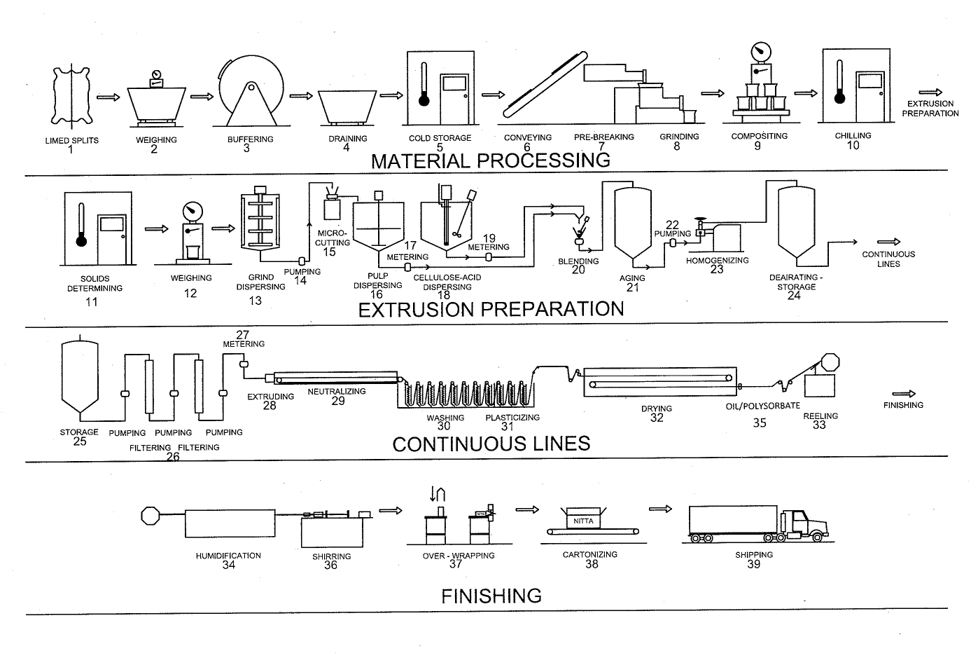

Conventional processes for producing edible collagen casing are known and have been described, for example, in U.S. Pat. No. 5,820,812, the entire contents of which are hereby incorporated by reference. The steps and equipment used in one embodiment of a typical process is shown schematically in FIG. 1. The present invention is not limited in this regard, and collagen casing made by any process can be treated by applying the polysorbate and vegetable oil mixture described herein.

In one typical process for producing collagen casings, hides from freshly slaughtered animals are de-fleshed, washed with water, and treated with lime to remove hair. The lime treated hides are split on a leather splitting machine to separate the grain layer from the corium layer, which is used to produce the collagen casings. “Hides” as used herein refers to the corium collagen layer that is used to produce the collagen casings. Referring to FIG. 1, the limed hides 1 are stored in a refrigerated storeroom that is maintained at 0-4° C. until further processed as described below.

The hides are first processed to prepare the hide material for extrusion into casings. The hides are weighed 2 and treated in a buffering drum 3, which is capable of handling up to 3000 Kg of product. In the buffering drum, the hides are first treated with an ammonium sulfate solution at a concentration in the range of about 0.5%-2.2% (w/w), then water washed. The hides are then further treated with a citric acid/sodium citrate solution having a concentration of about 0.0725-0.29% (w/w), followed by another water wash. The buffering process brings the pH of the corium layer down to approximately 4.3 to 4.9. Assays are run to ensure the product reaches the appropriate pH. The buffered hides are drained 4 and the buffered hides are placed in cold storage 5 until needed for further processing.

When additional material is needed for processing, the hides are sent on a conveyor 6 to be shredded 7 and ground 8 into a quarter grind (i.e., a material having a particle size of about one-quarter inch) at less than approximately 25° C. The quarter grind material is composited 9 and chilled 10 and maintained at a temperature of about 18° C.

The chilled quarter grind material is piped to the extrusion preparation line. The solids are measured 11 and weighed 12 and the quarter grind particles are dispersed in water 13. The dispersed quarter grind is pumped 14 to a high speed cutting mill 15 where the hide particles are further shredded to form a hydrated mass. The hydrated mass is stored and kept mixed in a pulp dispersion tank 16. In a separate blending tank 18, a dispersion of cellulose, HCl and water at 0 to 10° C. is prepared. In one embodiment, the dispersion is prepared at 5° C.

A quantity of the hydrated quarter grind particles from the pulp dispersion tank 16 is metered 17 into a blender 20. At the same time, a quantity of the cellulose-acid dispersion from blending tank 18 is metered 19 into the blender 20 and blended with the hydrated quarter grind particles to form a gel product. After an initial blend period of about 15 to 60 minutes, the gel product is stored in an aging tank 21 for about 20 hours under vacuum. The temperature of the storage tank is maintained at less than 20° C. The gel product is then pumped 22 to a homogenizer 23 and sent to a storage tank 24 where it is deaerated under vacuum. The gel product so obtained has the following approximate composition:

| Ingredient | Percent |
|---|---|
| Hide Solids | 4.2 to 5.3 |
| Cellulose | 0.90 to 1.70 |
| Hydrochloric Acid | 0.20 to 0.24 |

The gel product is maintained in storage tank 25 at about 25° C. The gel product is pumped from the storage tank through a series of filters 26, which may be any appropriate type of filter. Automatic self cleaning filters may be used. The filtered gel product is metered 27 to the extruder 28 to form the collagen casing. The extruder is preferably a disk extruder. At the extruder, the gel is extruded to a thickness from 0.075 to 1.2 thousands, formed, and inflated pneumatically to the desired diameter, typically about 13-34 mm. The collagen casing is treated with anhydrous ammonia in the neutralizing section 29. The ammonia reacts with and neutralizes the HCl in the product and causes coagulation of the collagen. The neutralized collagen casing is washed in a fresh water bath 30 to remove ammonia salts. The washed collagen casing then travels through a series of baskets 31 containing the plasticizer. The plasticizer solution is an aqueous solution containing about 2% to 6% glycerin, about 0.20% to 1.6% sodium carboxymethylcellulose or sodium alginiate, and about 0 to 20 ppm sodium hypochlorite. This process dehydrates the casing for drying purposes and allows introduction of glycerin for elasticity purposes.

The collagen casing travels through a dryer 32, which uses dry heat up to 205° F. The dryer may have multiple stages at different temperatures. After drying, the collagen casing is sent through one or more humidification chambers (not shown) at approximately 85% to 95% relative humidity. Afterward the humidification chambers, an oil based suspension of polysorbate in vegetable oil is applied to the film at room temperature 35. In one embodiment, the polysorbate is polysorbate 80. The amount of the polysorbate/vegetable oil suspension applied to the casing ranges from about 1% to about 6% of the total casing weight. In a preferred embodiment, the amount of the polysorbate/vegetable oil suspension applied to the ranges from about 3% to about 3.5% of the total casing weight. The polysorbate is mixed into the vegetable oil at a concentration ranging from about 0.3 to 1% (w/w).

The collagen casing is then collapsed and wound on a reel 33. The reeled casing is then sent for finishing and shipment. During the finishing process, moisture is added back to the casing by humidification 34. The casing is shirred 36 to its specified length and placed in boxes that are over wrapped and vacuum packed 37. The finished collagen casings are then boxed into FDA approved cardboard boxes 38, which are labeled, bar coded and scanned into the company's lot control system for traceability purposes. The ventilated boxes of slugs may then be placed in a humidification chamber, where forced humidified air is used to bring the moisture content of the product within specifications.

One skilled in the art will recognize that multiple extrusion preparation lines and multiple storage tanks for the gel product may be used to ensure a constant supply to the continuous extrusion line.

As will be recognized by those of ordinary skill in the pertinent art based on the teachings herein, numerous changes and modifications may be made to the above-described and other embodiments of the invention without departing from its scope. Accordingly, this detailed description of preferred embodiments is to be taken in an illustrative as opposed to a limiting sense.

We claim:

1. A collagen casing for meat products comprising a collagen casing having a suspension of polysorbate in vegetable oil on the outer surface.

2. The collagen casing of claim 1, wherein the suspension of polysorbate in vegetable oil comprises between about 1% to 6% of the total casing weight.

3. The collagen casing of claim 2, wherein the suspension of polysorbate in vegetable oil comprises between about 3% to 3.5% of the total casing weight.

4. The collagen casing of claim 2, wherein the polysorbate comprises between about 0.3% to 1% w/w of the suspension of polysorbate in vegetable oil.

5. The collagen casing of claim 4, wherein the polysorbate is polysorbate 80.

6. A method for finishing edible collagen casings, comprising applying to an extruded film of collagen casing at room temperature a suspension of polysorbate in vegetable oil.

7. The method of claim 6, wherein the suspension of polysorbate in vegetable oil is applied in an amount of between about 1 to 6% of the total casing weight.

8. The method of claim 6, wherein the suspension of polysorbate in vegetable oil is applied in an amount of between about 3 to 3.5% of the total casing weight.

9. The method of claim 6, wherein the polysorbate comprises between about 0.3% to 1% w/w of the polysorbate/vegetable oil suspension.

10. The method of claim 9, wherein the polysorbate is polysorbate 80.
